(19) United States
(12) Patent Application Publication
(10) Pub. No.: US 2021/0058515 A1
(43) Pub. Date: Feb. 25, 2021

(54) SYSTEMS AND METHODS FOR ENHANCING AUTOMATED CUSTOMER SERVICE FOR A CALLER

(71) Applicant: CAPITAL ONE SERVICES, LLC, McLean, VA (US)

(72) Inventor: Joerg RINGS, Chicago, IL (US)

(73) Assignee: Capital One Services, LLC, McLean, VA (US)

(21) Appl. No.: 16/544,725

(22) Filed: Aug. 19, 2019

(51) Int. Cl. H04M 3/51; G10L 15/20

(52) U.S. Cl. CPC H04M 3/5183; G10L 15/20; H04M 3/5175

(57) ABSTRACT

A system and method is provided for enhancing customer service for a caller. The system may perform operations including receiving call information from the caller, the received call information comprising voice data from a telephone conversation; measuring, based on call information, a level of background noise; determining, based on the level of background noise, a trigger of the background noise; classifying the call information based on the trigger; and modifying a call menu for providing to the caller, based on the classification.

### TECHNICAL FIELD

The present disclosure relates generally to an automated call system for analyzing acoustic data exchanged between callers and call center agents, and more particularly, to an automated call system that categorizes caller information based on background noise to identify an urgency of a call and/or a situation of a caller.

### BACKGROUND

Call centers have typically been used for commercial transactions, but also for help desk, customer support, emergency response, and outbound telemarketing purposes. Call centers have included Interactive Voice Response (IVR) systems and also human agents interacting directly with callers. However, many automated systems have become outdated and do not address caller concerns. Moreover, it is often difficult for automated systems to ascertain the intent of a caller prior to interacting with a caller. Further, call centers typically do not collect information related to background noise, but rather only rely on specific voice data or customer input, including for example, one or more manual numerical digits entered by a caller. As a result, call centers are usually unable to fully grasp the urgency of a call and/or the situation or reason for a call.

Therefore, what is needed is an Interactive Voice Response (IVR) automated system that improves interactions with callers The disclosed automated call system and methods address one or more of the problems set forth above and/or other problems in the prior art.

### SUMMARY

Disclosed embodiments provide an automated call system that enhances customer service via improved data collection and data analysis during a call. Disclosed embodiments may gather acoustic information associated with a call including voice data and background noise, and may enhance customer service for the caller based on this information. Furthermore, a dynamic workflow system may match unique caller voice data and simultaneously detect background noise during a call. Moreover, an automated system may collect both background noise information and other acoustic data from a caller during a call to grasp the urgency of a call or the situation or a caller. Additionally, an automated system may use background noise information and collected caller voice data to improve fraud prevention algorithms as well as marketing algorithms, and to adjust caller menus in real-time to enhance the customer experience for a caller.

One aspect of the present disclosure is directed to a system for enhancing customer service for a caller. The system may include a memory storing executable instructions, and at least one processor configured to execute the instructions to perform operations. The operations may include receiving call information from the caller, the received call information comprising voice data from a telephone conversation; measuring, based on call information, a level of background noise; determining, based on the level of background noise, a trigger of the background noise; classifying the call information based on the trigger; and modifying a call menu for providing to the caller, based on the classification.

Another aspect of the present disclosure is directed to method for enhancing customer service for a caller. The method may include receiving call information from the caller, the received call information comprising voice data from a telephone conversation; measuring, based on call information, a level of background noise; determining, based on the level of background noise, a trigger of the background noise; classifying the call information based on the trigger; and modifying a call menu for providing to the caller, based on the classification.

Yet another aspect of the present disclosure is directed to a non-transitory computer-readable medium storing instructions that, when executed by a processor, cause the processor to perform operations enhancing customer service for a caller. The operations may include receiving call information from the caller, the received call information comprising voice data from a telephone conversation; measuring, based on call information, a level of background noise; determining, based on the level of background noise, a trigger of the background noise; classifying the call information based on the trigger; and modifying a call menu for providing to the caller, based on the classification.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 is a block diagram of an exemplary system for providing customer service to a caller, consistent with disclosed embodiments.

FIG. 2 is a block diagram of another exemplary system for providing customer service to a caller, consistent with disclosed embodiments.

FIG. 3 is a block diagram of an electronic network layout for call center transaction verification, consistent with disclosed embodiments.

FIG. 4 is a schematic diagram of an exemplary computerized process for call center transaction verification, consistent with disclosed embodiments.

FIG. 5 is a block diagram of a classification of call information in a database, consistent with disclosed embodiments.

FIG. 6 is a flow chart of an exemplary process for enhancing customer service for a caller, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

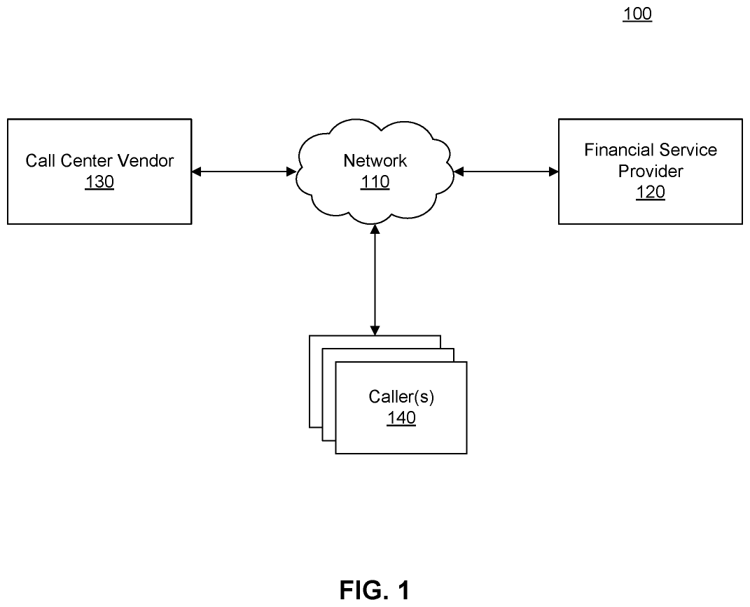

FIG. 1 is a diagram illustrating an exemplary system 100 for enhancing customer service for a caller. The components and arrangement of the components described in FIG. 1 may vary. For example, while some components of FIG. 1 are represented in a singular manner, in some embodiments, components may be combined, omitted, or duplicated. Furthermore, system 100 may additionally include other entities and/or sources of information that is associated with customer calls. As shown in FIG. 1, system 100 may include a network 110, financial service provider 120, call center vendor 130, and customer(s) or caller(s) 140.

Network 110 may be any type of network configured to provide communications between components of FIG. 1. For example, network 100 may be any type of network (including infrastructure) that provides communications, exchanges information, and/or facilitates the exchange of information, such as the Internet, a Local Area Network, or other suitable connection(s) that enables system 100 to send and receive information between the components of system 100.

Financial service provider 120 may provide a variety of financial services and/or products for customers or callers. In one aspect, the financial service provider may provide and manage credit card accounts. In certain aspects, each credit card account may be associated with a customer's financial service account managed by financial service provider 120. Financial service accounts may further include, for example, checking accounts, savings accounts, loans, and investment accounts. In one embodiment, financial service provider 120 may include a plurality of computing systems that are located at a central location or may include computing devices that are distributed (locally or remotely). In one example, financial service provider 120 may include a server that is configured to execute software instructions stored in a plurality of memory devices to perform a plurality of operations consistent with the disclosed embodiments.

Call center vendor 130 may include any entity having infrastructure capable of receiving and collecting data. For example, call center vendor 130 may receive incoming telephone calls and store call information in voice databases. Call data may include voice data and background noise. Call center vendor 130 may include a plurality of physical locations (brick and mortar location) with call centers comprising a plurality of agents. The agents may be human agents or may be artificial intelligence including, for example, a computing system capable of answering an incoming call and interacting with customers.

In some embodiments, the computing system may include an Interactive Voice Response (IVR) automated call system that includes an automated call menu presented to a caller. The automated call menu may include an audio recording including numbers for selection by tactile input or by voice selection from a caller, and the automated call menu may perform actions based on caller selection of particular numbers. In other embodiments, call center vendor 130 may include a plurality of computing systems to provide and manage a plurality of websites or mobile applications capable of receiving the incoming calls. Call center vendor 130 may be associated with financial service provider 120 or may be a separate entity. For example, in some embodiments, call center vendor 130 may include help desk, customer support, emergency response, and outbound telemarketing functions separate from financial transaction functions performed by financial service provider 120.

Customer(s) or caller(s) 140 may include a plurality of customers associated with financial service accounts of financial service provider 120. Additionally, or alternatively, customer(s) or caller(s) 140 may include a plurality of callers who are currently making and/or have previously made telephone or mobile calls directed to financial service provider 120, whether or not they have an account associated with financial service provider 120. Customer or caller(s) 140 may communicate with other components of system 100 using any suitable computer device and/or telephonic device.

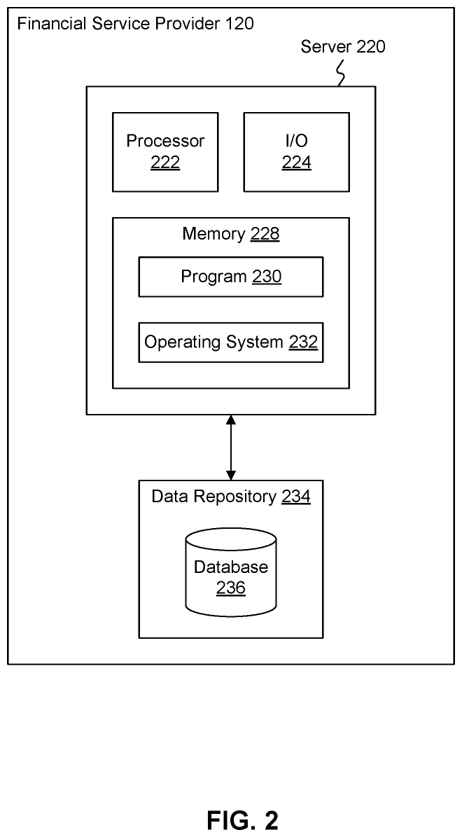

FIG. 2 shows an exemplary system that may be associated with a financial service provider and included in financial service provider 120. In one embodiment, the system includes a server 220 having a processor 222, input/output (I/O) devices 224, memory 228, a program 230, and an operating system 232. Alternatively, server 220 may take the form of a general purpose computer, a mainframe computer, or any combination of these components. Server 220 may be standalone, or it may be part of a subsystem, which may be part of a larger system.

Server 220 may also be communicatively connected to a data repository 234, as shown in FIG. 2. Server 220 may be communicatively connected to data repository 234 through network 110. Data repository 234 may include a plurality of files or a database 236 that stores information and is accessed and/or managed through server 220. By way of example, database 236 may be Oracle™ databases, Sybase™ databases, or other relational databases or non-relational databases, such as Hadoop sequence files, HBase, or Cassandra. The database or other files may include, for example, data and information related to the source and destination of a network request, the data contained in the request, etc. Systems and methods of disclosed embodiments, however, are not limited to separate databases. In one aspect, financial service provider 120 may include data repository 234. Alternatively, data repository 234 may be located remotely from financial service provider 120.

The disclosed embodiments may be used for examining voice data and background noise as part of received call information to verifying payment transactions identified as potentially fraudulent or for marketing and/or commercial purposes. Some disclosed embodiments enable a customer or caller to, after receiving a notification that a transaction has been suspended as potentially fraudulent, continue the transaction through identity verification. In some embodiments, identity verification may be performed using a voice data recognition system located, for example, on a mobile device.

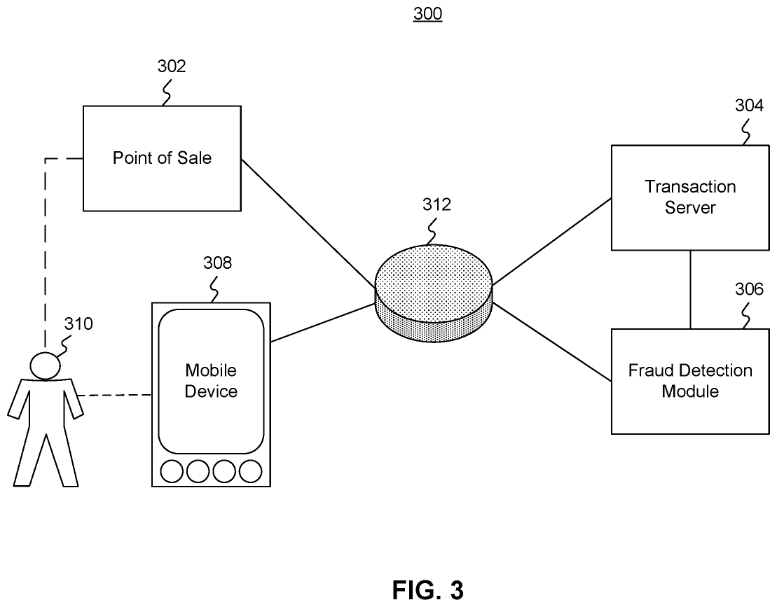

FIG. 3 discloses a system 300 including embodiments consistent with the present disclosure. While some components of FIG. 3 are represented in a singular manner, one of ordinary skill would understand that, in some embodiments, components may be combined, omitted, or duplicated.

In one embodiment, Point of Sale (POS) device 302 may represent a device configured to perform payment transaction processes. Customer(s) or caller(s) 310 may affect a payment transaction using POS device 302. For example, POS device 302 may be a stand-alone POS device, a cash register, an online retailer, a vending machine, or the like. In some embodiments, POS device 302 could be any form of device, system, or software, operated by customer(s) or caller(s) 310 or another entity such as a merchant (not shown) to effect payment transactions such as purchases, returns, exchanges, withdrawals (as in the case of, for example, a debit “cash back” transaction) or the like. For example, POS device 302 may include call center vendor 130 having an infrastructure capable of receiving and collecting call data effecting payment transactions or purchases. POS device 302 may further include a call center configured to receive calls placing a plurality of purchases and effecting multiple payment transactions.

Transaction server 304 may represent a device configured to execute software instructions to perform a plurality of processes consistent with the disclosed embodiments, such as processing payment transactions in a manner consistent with disclosed embodiments. In some aspects, transaction server 304 may represent a plurality of payment processors (for example, entities that supply authorization and settlement services for credit card transactions, or transmit funds between participating institutions), an issuing bank, a depository institution, a credit union, or any other device, system, or software that may be configured to process payment transactions. Processing of payment transactions may include, for example, processing purchase requests (by which a customer or caller's account may be debited), processing balance requests (by which a customer or caller's account balance may be returned), processing a return request (by which a customer or caller's account may be credited), or any other known/unknown payment request.

Fraud detection module 306 may be a device that may be configured to execute software instructions that enable the detection of potentially fraudulent transactions. For example, fraud detection module 306 may be operable to determine whether payment transactions are potentially fraudulent based on a combination of voice data sampled from a received call, background noise sampled from a received call, other acoustic sampled call data sampled from a received call, a plurality of past transactions of the customer or caller, past transactions of other customers or callers, historical lists of fraud transaction locations, the location of a customer(s) or caller(s) (based on, for example, the location of the customer(s) or caller(s)'s mobile device), occurrence of other callers' fraudulent transactions at the merchant, credit bureau data of the customer(s) or caller(s), or the like. In some embodiments, fraud detection module 306 may receive transaction data about a current payment transaction from transaction server 304; however, other arrangements are possible (for example, receiving transaction data directly from point of sale device 302). Fraud detection module 306 may be, in some embodiments, a plurality of computer devices. For example, fraud detection module 306 may be a server with a plurality of processors and a plurality of memory devices storing instructions that can be executed by the processor(s) to perform a plurality of operations consistent with the disclosed embodiments

Fraud detection module 306 may, using information (such as the above-mentioned information) determine whether a transaction is more likely than not to be fraudulent. If so, fraud detection module 306 may perform process(es) to attempt to halt or suspend the suspect transaction (and may also “flag” the transaction as fraudulent). In some embodiments, this may be done by communicating with transaction server 304 and/or point of sale device 302; however, other arrangements for halting, suspending, and/or flagging suspect transactions are possible with the disclosed embodiments. In one aspect, fraud detection module 306 may flag a suspect transaction as fraudulent by assigning a value in a flag field included, or attached to, a transaction record associated with the suspect transaction under analysis by fraud detection module 306. Fraud detection module 306 may send a message to server 304 and/or POS device 302 including the flagged transaction, or alternatively, may send a message including an alert indicating that the suspect transaction is fraudulent. In some embodiments, where loud background noise may serve as an indicator of a lost credit card, it may also simultaneously decrease the likelihood that a caller wants to make a payment. The lost credit card, however, may or may not be indicative of fraudulent activity capable of detection by fraud detection module 306.

While FIG. 3 depicts transaction server 304 and fraud detection module 306 as separate components, the disclosed embodiments may include configurations where these elements are part of the same component. Similarly, the disclosed embodiments may include configurations where transaction server 304 and server 220 of financial service provider 120 (as shown in FIG. 2) are part of the same component.

Mobile device 308 may be a smartphone, a mobile phone, a portable electronic device, tablet, a personal digital assistant, or any other electronic device with communication. Mobile device 308 may also include voice capabilities. In certain aspects, mobile device 308 may be configured to enable customer(s) or caller(s) 310 to authorize a transaction that has been flagged as potentially fraudulent.

In some embodiments, mobile device 308 may include, for example, a display, a processor, storage (temporary/permanent/flash memory), input devices (such as a keyboard, a touchscreen, a microphone, a data port such as USB, or the like), output devices (such as speakers, headphone ports, or the like), communication mechanisms (such as hardware, software, firmware, or a combination, for implementing communication protocols, including wireless protocols such as Wi-Fi, Bluetooth, cellular telephony, LTE/CDMA/GSM, NFC, RF, or the like), or other components for use with mobile devices, smart phones, or the like. One of ordinary skill will recognize that any or all of these components can be combined, omitted, or duplicated. Mobile device 308 may include software instructions stored in memory that, when executed by a plurality of processors, perform a plurality of operations consistent with the disclosed embodiments. In one aspect, mobile device 308 may include a mobile application that generates interfaces that are displayed on a display device to request and receive input from customer(s) or caller(s) 310.

Customer(s) or caller(s) 310 may be a purchaser who is attempting to effect a payment transaction using a plurality of financial accounts. In some embodiments, customer(s) or caller(s) 310 may possess mobile device 308, and mobile device 308 may be associated with customer(s) or caller(s) 310 and his or her payment accounts.

Network 312 may be any type of network configured to provide communications between components of FIG. 3, including those described above. For example, network 312 may be any type of network (including infrastructure) that provides communications, exchanges information, and/or facilitates the exchange of information, such as the Internet, a Local Area Network, cellular and/or landline telephone networks, or other suitable connection(s) that enables system 300 to send and receive information between the components of system 300. In other embodiments, a plurality of components of system 300 may communicate directly through a dedicated communication medium.

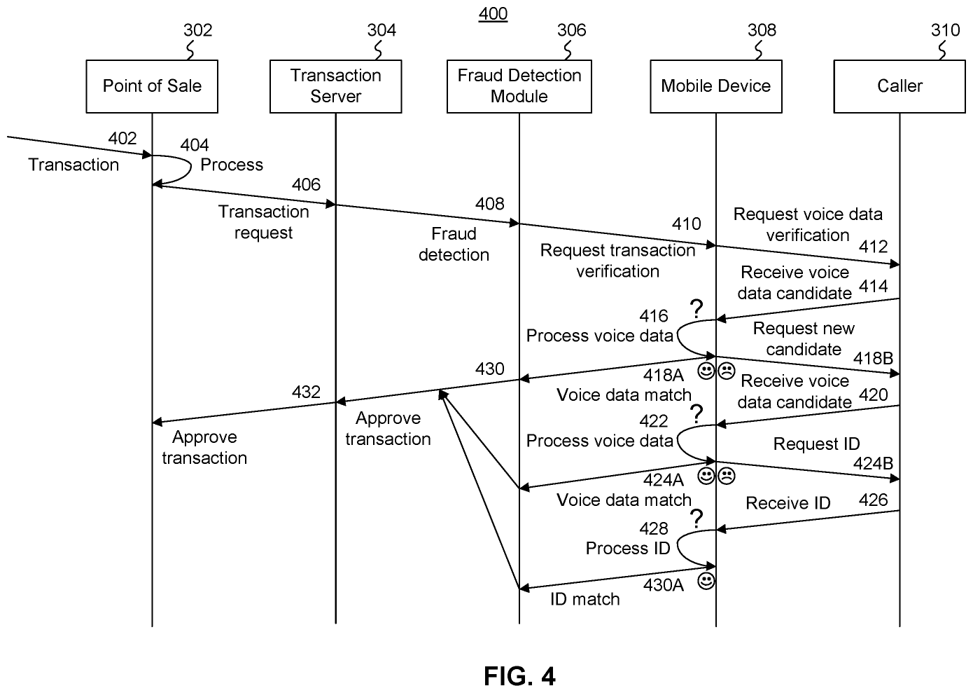

FIG. 4 is a diagram of an exemplary computerized process 400 for implementing embodiments consistent with the present disclosure. As will be understood by one of ordinary skill, the diagram and its order of operations are merely exemplary. Thus, as will be understood by one of ordinary skill, disclosed steps may be performed in a different order, repeated, omitted, or may vary from those steps explicitly disclosed in FIG. 4.

A payment transaction may begin at step 402 when a transaction is received by POS device 302. For example, customer(s) or caller(s) 310 may attempt to make a purchase at POS device 302 by tendering a credit card or other payment means. At step 404, POS device 302 may attempt to process the transaction. This may include, for example, determining that transaction server 304 may process the transaction. For example, if POS device 302 is attempting to process a transaction using a particular brand of credit card, and transaction server 304 may represent a server associated with a financial service provider 120 for that particular credit card. Using known POS transaction processes, POS device 302 may determine that transaction server 304 should be used to process the transactions. Other procedures and systems for processing transactions may be implemented as part of this step, as one of ordinary skill will recognize.

In step 406, POS device 302 may generate and send a transaction request to transaction server 304. In one aspect, transaction request may include transaction information reflecting the transaction, such as amount, payment account used to attempt the purchase, timestamp information, merchant information, etc.

Transaction server 304, after receiving the transaction request in step 406, may generate and send a fraud detection request to fraud detection module 306 (step 408).

Fraud detection module 306 may receive the fraud detection request and perform processes for determining whether the transaction is potentially fraudulent. In one embodiment, upon determining that the transaction referenced by the transaction request is potentially fraudulent, fraud detection module 306 may generate and send a transaction verification request to mobile device 308 (step 410).

In one embodiment, fraud detection module 306 may also “pause” or “suspend” the transaction while mobile device 308 is processing the transaction verification. Suspending the transaction may comprise, for example, sending a message to transaction server 304 to halt processing of the transaction request until verification of the transaction is completed; however, other arrangements are possible as well.

In response to the transaction verification request, mobile device 308 may alert customer(s) or caller(s) 310 that the transaction has been flagged as potentially fraudulent. Alerting the customer(s) or caller(s) 310 may include, for example, alerting the customer(s) or caller(s) 310 through a mobile application executing on mobile device 308. For example, mobile device 308 may execute software that generates an interface that is displayed on a display device that identifies the transaction as potentially fraudulent. Alerting the customer(s) or caller(s) 310 may be accomplished by a number of known or unknown methods. For example, a sound alert, a vibrating alert, a visual alert, or the like may alert customer(s) or caller(s) 310.

In one aspect, mobile device 308 may execute software that generates and presents a voice data verification request (step 412). In one aspect, mobile device 308 may execute software that may prompt customer(s) or caller(s) 310 to vocalize a password that corresponds to customer(s) or caller(s) 310's previously-recorded voice data. In another aspect, mobile device 308 may execute software to determine a level of background noise associated with voice data to identify an urgency of customer(s) or caller(s) 310. Fraud detection module 306 may verify whether the background noise is representative of fraudulent activity or not.

In certain embodiments, mobile device 308 may be configured to assist customer(s) or caller(s) 310 in recalling the requested voice data. For example, mobile device 308 may execute software instructions that display the voice data on a display of the mobile device. In other embodiments, mobile device 308 may provide the customer(s) or caller(s)'s 310 voice data via sound files, such as playing an audio rendition of the voice data of customer(s) or caller(s) 310 through a headphone, headset, speaker, or the like. This enables the customer(s) or caller(s) to recall what password customer(s) or caller(s) 310 may be required to say to verify the transaction. In some embodiments, the password is not displayed on the device. In other embodiments, there may be a brief reminder about the contents of the password, or a customer or caller defined hint that may be implemented by the disclosed embodiments.

Mobile device 308 may receive a candidate voice data from customer(s) or caller(s) 310 (step 314). This may include, for example, customer(s) or caller(s) 310 speaking the voice data candidate into a headset or microphone of mobile device 308, such that mobile device 308 may receive the candidate voice data from customer(s) or caller(s) 310. Candidate voice data may or may not be accompanied by background noise which may be stored separate from spoken voice data.

At step 416, mobile device 308 may execute software instructions to process the received candidate voice data. For example, mobile device 308 may compare the received candidate voice data with a pre-recorded voice data associated with customer(s) or caller(s) 310, such as, for example, the voice data set by a customer(s) or caller(s) when configuring a password. Mobile device 308 may also execute software instructions to compare detected background noise with pre-recorded background noise data associated with customer(s) or caller(s) 310. The disclosed embodiments may implement known voice comparison processes, algorithms, and/or systems to process the received candidate voice data. For example, mobile device 308 may include and execute known speech recognition technologies to compare the candidate voice data with the pre-recorded voice data associated with customer(s) or caller(s) 310. The disclosed embodiments may implement speech recognition processes that allow for variations in speech and sound, such that the received candidate voice data and the pre-recorded voice data need not be an exact match to pass verification. Rather, a “match rate” or voice and wavelength thresholds may be applied to determine whether the candidate voice data is an accurate voice data for customer(s) or caller(s) 310. For example, mobile device 308 may execute processes that determines whether a match rate between the pre-recorded voice data and the candidate voice data received in step 414 is equal to or higher than a determined threshold value, such as, for example, a 85% match. As another example, mobile device 308 may execute processes that determines whether a match rate between the pre-recorded background noise data and received background noise data equal to or higher than a determined threshold value

If mobile device 308 determines that there is a voice data match (step 418A), mobile device 308 may generate and send a message to indicate to fraud detection module 306 that the transaction is not fraudulent and that the transaction processing should be completed. Fraud detection module 306 may receive the message from mobile device 308 and perform processes to approve the transaction (step 430). In other embodiments, mobile device 308 may send to fraud detection module 306 the candidate voice data for processing. For instance, fraud detection module 306 may perform processes that process the received candidate voice data, compare the candidate voice data to a stored version of customer(s) or caller(s) 310's pre-recorded voice data to determine a match rate, and determine based on the comparison whether the transaction processing should be completed. At step 430, fraud detection module 306 may generate and send a message to transaction server 304 to approve the transaction. Transaction server 304 may receive the approval message from fraud detection module 306 and in response, generate and send a message to POS device 302 to approve the transaction.

In some situations, however, mobile device 308 may determine that customer(s) or caller(s) 310 has not authorized the transaction. For example, the match rate between the candidate voice data received in step 414 and the previously-recorded voice data may be lower than a predetermined determined value. This may occur, for example, when there is too much background noise when customer(s) or caller(s) 310 inputs the candidate voice data and/or when the background noise is identified as a particular type. For example, the background noise may be loud and may indicate a customer(s) or caller(s) 310 are located inside of a restaurant or bar, which may or may not trigger that the customer(s) or caller(s) 310 have not authorized the transaction. This may also occur, for example, when customer(s) or caller(s) 310 may not have responded during a timeout period (e.g., because customer(s) or caller(s) 310 were not aware of an alert on mobile device 308). If mobile device 308 (or fraud detection module 306) determines that the candidate voice data does not match the pre-recorded voice data of the customer(s) or caller(s), mobile device 308 may send a message to fraud detection module 306 indicating that a match is not made. In other embodiments, fraud detection module 306 may determine that there is no match based on the received candidate voice data from mobile device 308. In response to a determination of no match, in some embodiments, fraud detection module 306 may determine that the transaction is fraudulent. Based at least on the determination that the transaction is fraudulent, fraud detection module 306 may send a message to transaction server 304 (as mentioned above) to deny the transaction. Transaction server 304 may also send a message to POS device 302 denying the transaction.

In some embodiments, however, if a match is not made, mobile device 308 may re-initiate the verification process and/or initiate other verification procedures. For example, at step 418B, mobile device 308 may request a second candidate voice data from customer(s) or caller(s) 310 or may request background noise representative as the second candidate voice data from a customer call. In some embodiments, the request for a second candidate voice data may be conditioned on the receipt of additional verified identification information. For example, mobile device 308 may execute software instructions that generate a prompt for the customer(s) or caller(s) to go to a less noisy location (e.g. with less background noise) if mobile device 308 determines that the received candidate voice data at step 420 could not be processed because of excess background noise. Mobile device 308 may process the second candidate voice data at step 422, using the same or similar methods mentioned above with respect to step 416. If mobile device 308 determines that the second candidate voice data matches the customer(s) or caller(s)'s pre-recorded voice data (e.g., the match rate for the second candidate voice data is sufficiently high), mobile device 308 may generate and send a message to fraud detection module 306 to approve the transaction in step 424A and the transaction approval process continues as disclosed above in connection with steps 430 and 432.

However, if mobile device 308 determines that the second candidate voice data does not match the customer(s) or caller(s)'s 310 pre-recorded voice data (e.g., the match rate of the second candidate voice data is too low, the second candidate voice data input includes too much noise information, no response is received, etc.), in step 424B, mobile device 308 may prompt customer(s) or caller(s) 310 to enter a unique identifier (ID) to authorize the transaction. In some embodiments, the requested ID may correspond to the ID set by the customer(s) or caller(s) 310. Other IDs are possible as well (such as an ATM card ID associated with customer(s) or caller(s), an online banking password associated with customer(s) or caller(s), or the like). Mobile device 308 may receive an ID input from customer(s) or caller(s) 310 (step 426). In certain aspects, customer(s) or caller(s) 310 may enter the ID by, for example, pressing keys representing the ID, speaking the ID into mobile device 308, actuating a screen or keys on the device to enter the ID, or the like.

In step 428, mobile device 308 may process the ID received in step 426 to determine whether the transaction is fraudulent or not. If the ID received in step 426 matches a previously-stored ID, mobile device 308 may then send a message to fraud detection module 306 to approve the transaction in step 430A (as mentioned above). If not, mobile device 308 may send a denial message in 430A (as mentioned above).

In certain embodiments, if no response to the transaction verification request is received by fraud detection module 306 within a certain amount of time, fraud detection module 306 may “time out.” In some embodiments, after timing out, fraud detection module 306 may conclude that customer(s) or caller(s) 310 would not authorize this transaction, and send a message to transaction server 304 (as mentioned above) to deny the transaction. Similarly, if customer(s) or caller(s) 310 do not respond to the requests from mobile device 308 (in exemplary FIG. 4, the requests in steps 412, 4188, and 424B), mobile device 308 may also time out, conclude that customer(s) or caller(s) 310 would not authorize this transaction, and send a message to fraud detection module 306 to deny the transaction. Fraud detection module 306 may then send a message to transaction server 304 to deny the transaction as mentioned above.

Other methods for measuring voice data, measuring, based on call information, a level of background noise, and determining, based on the level of background noise, a trigger of the background noise, to identify whether or not there exists fraud, may be contemplated. For example, predetermined threshold values indicating a higher level of background noise may correlate with a lower risk of fraud as consistent with this disclosure. Similarly, other methods for measuring voice data, measuring, based on call information, a level of background noise, and determining, based on the level of background noise, a trigger of the background noise, to identify optimum marketing or cross-selling strategies for call center vendors may be contemplated consistent with this disclosure.

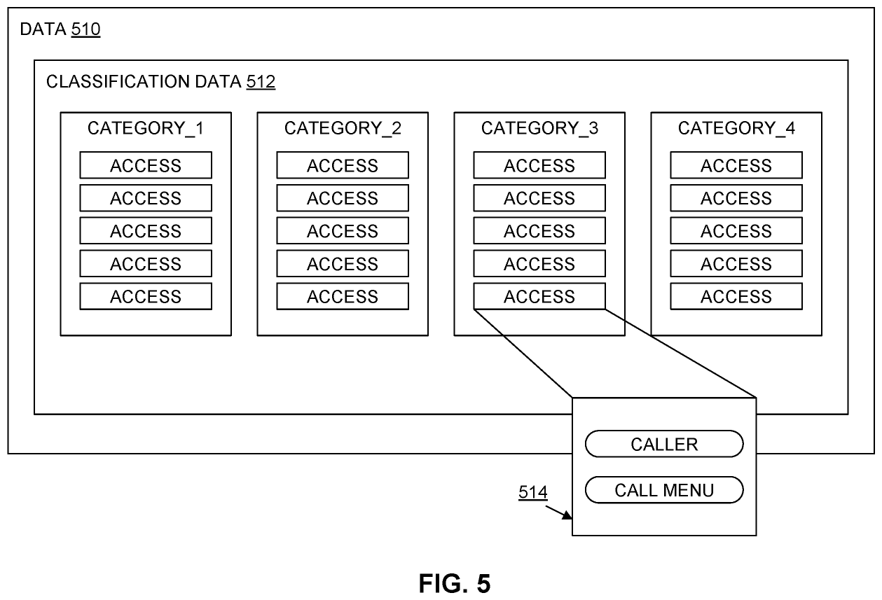

FIG. 5 depicts a diagram of classification of call information in a database, consistent with disclosed embodiments. Data 510 collected from calls may specifically include classification data 512 which may include a plurality of stored categories of classification information. Categorization may be based on customer(s) or caller(s)'s 310 voice data or based on detected and identified background noise level from a call. For example, categorization may be used to indicate when cross-selling attempts may occur based on a quiet setting. Categorization may also be used to indicate a higher level of background noise potentially indicating a smaller likelihood of fraud. A lower level of background noise may also be categorized to indicate a higher likelihood of fraud. Threshold decibel and frequency or wavelength levels relating to captured voice data and background noise data may be categorized and stored. Stored data 514 may include voice data, background noise data, and both the name ID of the caller of a call and a call menu used during a call. A call menu may be modified to enhance the customer service experience for a caller, and/or to improve fraud detection.

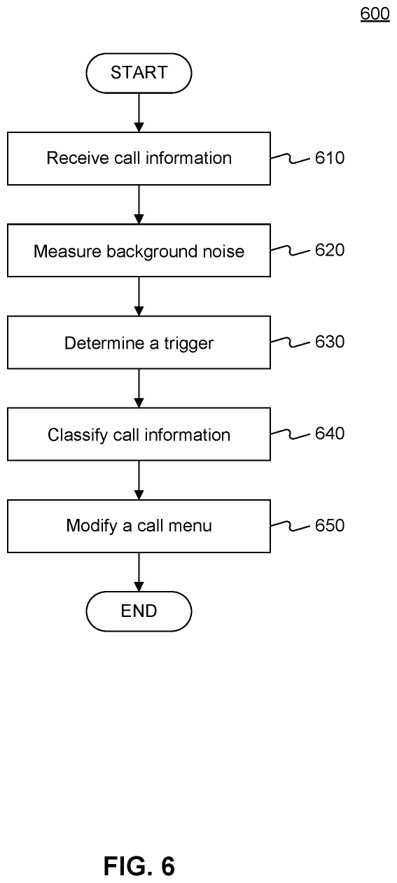

FIG. 6 depicts a flow chart of an exemplary process 600 for enhancing customer service for a caller, consistent with disclosed embodiments. In step 610, financial service provider 120 or transaction server 304 may receive call information from the caller, and the received call information may include voice data from a telephone conversation. The received call information may include a plurality of identifying features comprising a date of the telephone conversation, a time of the telephone conversation, a duration of the telephone conversation, a caller identifier, a call center identifier, and the like.

In step 620, financial service provider 120 or transaction server 304 may measure, based on received call information, a level of background noise. Financial service provider 120 may analyze, based on an acoustic sampling, received call information to determine acoustic properties of a telephone conversation. Acoustic properties may include decibel level, frequency level, acoustical waveform, acoustic pattern, wavelength, or other properties. In some embodiments, mobile device 308 or call center vendor 130 may determine that customer(s) or caller(s) 310 have not authorized a transaction. For example, a match rate between the candidate voice data received in step 414 (of FIG. 4) and the previously-recorded voice data may be lower than a predetermined determined value. This may occur, for example, when there is too much background noise when customer(s) or caller(s) 310 inputs the candidate voice data and/or when the background noise is identified as a particular type. For example, the background noise may be loud and may indicate a customer(s) or caller(s) 310 are located inside of a restaurant or bar, which may or may not trigger an indication that the customer(s) or caller(s) 310 have or have not authorized the transaction. In some embodiments, mobile device 308 may execute software instructions that generate a prompt for the customer(s) or caller(s) 310 to move to a less noisy location (e.g. with less background noise) if mobile device 308 determines that received voice data could not be processed because of excess background noise.

In step 630, financial service provider 120 or transaction server 304 may determine, based on the level of background noise, at least one trigger of the background noise. The at least one trigger may be identified based on the acoustic sampling, wherein the sampling includes a decibel and frequency level determination for the caller, and a determination the caller's voice data changed during the duration of the telephone conversation. The change may be a change in decibel, pitch, or frequency level or may include other changes. Financial service provider 120 or transaction server 304 may determine the at least one trigger for telephone conversations having a number of acoustic properties exceeding a predetermined threshold. The at least one trigger may include information indicating the situation of the caller, including for example, whether a caller is at home or at a bar, based on a detection of the background noise. Other types of situations describing a location or locale of a caller may be contemplated.

In step 640, financial service provider 120 or transaction server 304 may classify, based on the at least one trigger identified in the voice data, the call information. The trigger may include a level or background noise or may also include a situation of the caller, including for example, whether a caller is at home or at a bar, Financial service provider 120 or transaction server 304 may classify the call information into a plurality of classification categories, the classification categories including at least high and low levels of background noise. Financial service provider 120 or transaction server 304 may store classification categories in a searchable database, retrieve call information from the classification categories, and compare received call information with stored call information to determine a classification for received call information. Categorization may be based on customer(s) or caller(s)'s 310 voice data or based on detected background noise level from a call. For example, categorization may be used to indicate when cross-selling attempts may occur based on a quiet setting (without any background noise). Categorization may also be used to indicate a higher level of background noise indicating a smaller likelihood of fraud. A lower level of background noise may also be categorized to indicate a higher likelihood of fraud. For example, background noise at a bar may be representative of a higher level of background noise, and background noise at a home setting or at a library may be representative of a lower level of background noise. Categorization may be used to group detected background noise in a binary fashion representative of a restaurant or bar in contrast with a home or library setting, or a plurality of different categories representative of multiple background noise levels may be contemplated (as shown in FIG. 5). Where background noise is detected at a bar representative of a higher level of background noise, a smaller likelihood of fraud may be indicated. Conversely, where background noise is detected at a home setting or at a library representative of a lower level of background noise, a higher level of fraud may be indicated. Alternatively, higher levels of fraud may be indicated where higher background noise is detected, and lower levels of fraud may be indicated where lower background noise is detected.

In step 650, financial service provider 120 or transaction server 304 may modify, based on the classification or categorization of the call information, a call menu for providing to the caller. The call menu may include a plurality of automatic acoustic prompts requesting caller input. As shown in FIG. 5, stored data 514 may include voice data, background noise data, and both the name ID of the caller of a call and a call menu used during a call. A call menu may be modified in real-time during a call to enhance the customer service experience for a caller, and/or to improve fraud detection. Numbers or options available for selection for a caller may be modified based on a comparison with included voice data and background noise collected from a caller.

In some embodiments, the automated call menu may include an audio recording including numbers for selection by tactile input or by voice selection from a caller, and in other embodiments automated call menu may perform actions based on caller selection of particular numbers. Actions may include collecting of caller information or advancing to a next audio recording prompt or call menu. The automated call menu may be modified to enhance customer service based on classification or categorization of the call information. For example, where background noise is detected to be loud at a bar or restaurant, and a level of fraud may be indicated to be lower, then the automated call menu may change and present questions to a caller that are not oriented to fraud detection. Conversely, where background noise is detected to be quiet at a home or library, and a level of fraud may be indicated to be higher, then the automated call menu change and present questions to a caller that are specifically oriented to fraud detection. For example, the automated call menu may ask for the caller's social security information or other personal information to verify the caller is an actual cardholder for a payment transaction. Other types of real-time call menu adjustments may be contemplated consistent with this disclosure.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

1. A system for enhancing customer service for a caller, the system comprising:
at least one memory storing instructions; and
at least one processor configured to execute the instructions to perform operations comprising:
receiving call information from the caller, the received call information comprising voice data from a telephone conversation;
measuring, based on the call information, a level of background noise;
analyzing the call information to determine a decibel level for the voice data, a frequency level for the voice data, an acoustical waveform for the voice data, and an acoustic pattern for the voice data;
determining, based on the level of background noise, a trigger of the background noise, wherein:
the trigger includes a situational indicator of the caller, wherein the situational indicator is selected from a plurality of situational indicators, and
the trigger is identified from:
a comparison of the decibel level to a threshold decibel level,
a comparison of the frequency level to a threshold frequency level,
a comparison of the acoustical waveform to a threshold acoustical waveform for the voice data, and
a comparison of the acoustic pattern to a threshold acoustic pattern for the voice data,
wherein the threshold decibel level, the threshold frequency level, the threshold acoustical waveform, and the threshold acoustic pattern are associated with the situational indicator of the caller;
classifying the call information based on the trigger into one of a plurality of classification categories, wherein the each of the plurality of classification categories corresponds to one of the plurality of situational indicators; and
providing a call menu to the caller, the call menu comprising a plurality of automatic acoustic prompts requesting caller input, the prompts being generated based on the classification.

2. The system of claim 1, wherein the received call information comprises a plurality of identifying features.

3. The system of claim 2, wherein the identifying features comprise at least one of a date of the telephone conversation, a time of the telephone conversation, a duration of the telephone conversation, a caller identifier, or a call center identifier.

4. (canceled)

5. The system of claim 4, wherein:
the trigger is identified based on the acoustic sampling; and
analyzing the call information further comprises:
determining a decibel and frequency level for the voice data; and
determining whether the voice data changed during the duration of the conversation.

6. The system of claim 2, wherein identifying the trigger comprises determining that the conversation has a number of acoustic properties exceeding a predetermined threshold.

7. (canceled)

8. The system of claim 1, wherein the operations further comprise:
storing the plurality of classification categories in a searchable database;
retrieving call information from the plurality of classification categories; and
comparing the voice data with the retrieved call information to determine a classification for the voice data.

9. (canceled)

10. A method for enhancing customer service for a caller, comprising:
receiving call information from the caller, the received call information comprising voice data from a telephone conversation;
measuring, based on received call information, a level of background noise;
analyzing the call information to determine a decibel level for the voice data, a frequency level for the voice data, an acoustical waveform for the voice data, and an acoustic pattern for the voice data;
determining, based on the background noise level, a trigger of the background noise, wherein:
the trigger includes a situational indicator of the caller, wherein the situational indicator is selected from a plurality of situational indicators, and
the trigger is identified from:
a comparison of the decibel level to a threshold decibel level,
a comparison of the frequency level to a threshold frequency level,
a comparison of the acoustical waveform to a threshold acoustical waveform for the voice data, and
a comparison of the acoustic pattern to a threshold acoustic pattern for the voice data,
wherein the threshold decibel level, the threshold frequency level, the threshold acoustical waveform, and the threshold acoustic pattern are associated with the situational indicator of the caller;
classifying the call information, based on the trigger into one of a plurality of classification categories, wherein the each of the plurality of classification categories corresponds to one of the plurality of situational indicators;
providing a call menu to the caller, the call menu comprising a plurality of automatic acoustic prompts requesting caller input, the prompts being generated based on the classification, and
providing the call menu to the caller.

11. The method of claim 10, wherein the received call information comprises a plurality of identifying features.

12. The method of claim 11, wherein the identifying features comprise at least one of a date of the telephone conversation, a time of the telephone conversation, a duration of the telephone conversation, a caller identifier, or a call center identifier.

13. (canceled)

14. The method of claim 10, wherein the trigger is identified based on the acoustic sampling; and
analyzing the call information further comprises:
determining whether the voice data changed during the duration of the conversation.

15. The method of claim 13, further comprising:
identifying the trigger comprises determining that the conversation has a number of acoustic properties exceeding a predetermined threshold.

16. (canceled)

17. The method of claim 10, further comprising:
storing the plurality of classification categories in a searchable database;
retrieving call information from the plurality of classification categories; and
comparing the voice data with retrieved call information to determine a classification for the voice data.

18. (canceled)

19. A non-transitory computer-readable medium storing instructions for enhancing customer service for a caller, the instructions operable to cause a plurality of processors to perform operations, comprising:
receiving call information from the caller, the received call information comprising voice data from a telephone conversation;
measuring, based on received call information, a level of background noise;
analyzing the call information to determine a decibel level for the voice data, a frequency level for the voice data, an acoustical waveform for the voice data, and an acoustic pattern for the voice data;
determining, based on the background noise level, a trigger of the background noise, wherein:
the trigger includes a situational of the caller, wherein the situational indicator is selected from a plurality of situational indicators, and
the trigger is identified from:
a comparison of the decibel level to a threshold decibel level,
a comparison of the frequency level to a threshold frequency level,
a comparison of the acoustical waveform to a threshold acoustical waveform for the voice data, and
a comparison of the acoustic pattern to a threshold acoustic pattern for the voice data,
wherein the threshold decibel level, the threshold frequency level, the threshold acoustical waveform, and the threshold acoustic pattern are associated with the situational indicator of the caller;
classifying the call information, based on the trigger into one of a plurality of classification categories, wherein the each of the plurality of classification categories corresponds to one of the plurality of situational indicators;
providing a call menu to the caller, the call menu comprising a plurality of automatic acoustic prompts requesting caller input, the prompts being generated based on the classification; and
providing the call menu to the caller.

20. The computer-readable medium of claim 19, wherein the received call information comprises a plurality of identifying features.
